(19) United States
(12) Patent Application Publication
(10) Pub. No.: US 2003/0076982 A1
(43) Pub. Date: Apr. 24, 2003

(54) Multiple hypothesis method of optical flow

(76) Inventors: Harpreet S. Sawhney, Westwindsor, NJ (US); Hai Tao, Santa Cruz, CA (US)

Correspondence Address: RATNERPRESTIA, P.O. BOX 980, VALLEY FORGE, PA, 19482-0980, US

(21) Appl. No.: 09/982,691

(22) Filed: Oct. 18, 2001

(51) Int. Cl. G06K 9/00

(52) U.S. Cl. 382/107

(57) ABSTRACT

The system generates novel views by an improved optical flow method, which uses multiple hypotheses. This method starts with the selection of a first image and a second image from a plurality of digital images. Then the second image is separated into discrete sections and the first image is separated into a number of features. It is hypothesized that each feature may map into any of the discrete sections of the second image. A direct optical flow method is used to find the local optimal solution for each feature in each hypothesized section. Finally a globally optimal solution is selected for each feature from among the local solutions.

The U.S. Government has a paid-up license in this invention and the right in limited circumstances to require the patent owner to license others on reasonable terms as provided for by the terms of contract no. DAAB07-98-D-H751 awarded by DARPA.

### FIELD OF THE INVENTION

The present invention is directed toward the domain of image processing, in particular toward the determination of correlations between two images.

### BACKGROUND OF THE INVENTION

Tremendous progress in the computational capability of integrated electronics and increasing sophistication in the algorithms for smart video processing has lead to special effects wizardry, which creates spectacular images and otherworldly fantasies. It is also bringing advanced video and image analysis applications into the mainstream. Furthermore, video cameras are becoming ubiquitous. Video CMOS cameras costing only a few dollars are already being built into cars, portable computers and even toys. Cameras are being embedded everywhere, in all variety of products and systems just as microprocessors are.

At the same time, increasing bandwidth on the Internet and other delivery media has brought widespread use of camera systems to provide live video imagery of remote locations. This has created a desire for an increasingly interactive and immersive tele-presence, a virtual representation capable of making viewers feel that they are truly at the remote location. In order to provide coverage of a remote site for a remote tele-presence, it is desirable to create representations of the environment that allow realistic viewer movement through the site. The environment consists of static parts (building, roads, trees, etc.) and dynamic parts (people, cars, etc.). The geometry of the static parts of the environment can be modeled offline using a number of well-established techniques. None of these techniques has yet provided a completely automatic solution for modeling relatively complex environments, but because the static parts do not change, offline, non-real time, interactive modeling may suffice for some applications. A number of commercially available systems (GDIS, PhotoModeler, etc.) provide interactive tools for modeling environments and objects.

In tele-presence applications with dynamic scenes both modeling and rendering are desirably performed online in real-time. The method used is desirably applicable to a wide variety of scenes that include human objects, yet should not preclude capture and rendering of other scenes. For human forms, it may be argued that assuming a generic model of the body and then fitting that model to images may be a viable approach. Still, there are unsolved issues of model to image correspondence, initialization and optimization that may make the approach infeasible.

Image-based modeling and rendering, as set forth in “Plenoptic Modeling: An Image-Based Rendering System” by L. McMillan and G. Bishop in SIGGRAPH 1995, has emerged as a new framework for thinking about scene modeling and rendering. Image-based representations and rendering potentially provide a mix of high quality rendering with relatively scene independent computational complexity. Image-based rendering techniques may be especially suitable for applications such as tele-presence, where there may not be a need to a cover the complete volume of views in a scene at the same time, but only to provide coverage from a certain number of viewpoints within a small volume. Because the complexity of image-based rendering is of the order of the number of pixels rendered in a novel view, scene complexity does not have a significant effect on the computations.

For image-based modeling and rendering, multiple cameras may be used to capture views of the dynamic object. The multiple views are synchronized at any given time instant and are updated continuously. The goal is to provide 360 degrees coverage around the object at every time instant from any of the virtual viewpoints within a reasonable range around the object.

Between the real cameras, virtual viewpoints may be created by tweening images from the two nearest cameras. Optical flow methods are commonly used to create tweened images. Unfortunately, the standard optical flow methods are notorious for their inability to handle several problems that arise in tweening. Particularly problematic are the difficulties of traditional optical flow with: large motions especially of thin structures, for example the swing of a baseball bat; and occlusion/deocclusions, for example between a person's hands and body. Additionally, for traditional optical flow methods to work well, cameras need to be closely spaced (<6-8 degrees apart). The number of cameras has an impact on the amount of overall hardware and software used by a system. Therefore, the need to place the cameras very close together may make the cost of a system prohibitive for broad range tele-immersive applications. Also, the tediousness of this physical set up may make it impractical to deploy the system in many settings such as office and home environments. Finally, correspondence maps between neighboring cameras allow interpolation only along the path between the cameras. Optical flow based correspondence by definition only provides image-based correspondences between points in a pair of views.

Traditional optical flow based tweening methods are clearly limited in their ability to provide view coverage with an optimal number of cameras and associated hardware. However in specific applications, such as special effects in movies and advertisements, such methods are already being used. In these situations flexibility of coverage and uncontrolled scenes are not issues because the techniques are used in a post-production setting. Therefore, large numbers of cameras can be used and scenes can be engineered.

### SUMMARY OF THE INVENTION

The present invention is embodied in an improved optical flow method, using multiple hypotheses. This method starts with the selection of a first image and a second image from a plurality of digital images. Then the second image is separated into discrete sections and the first image is separated into a number of features. It is hypothesized that each feature may map into any of the discrete sections of the second image. A direct optical flow method is used to find the local optimal solution for each feature in each hypothesized section. Finally a globally optimal solution is selected for each feature from among the local solutions.

### BRIEF DESCRIPTION OF FIGURES

FIG. 1 is a diagram of a pyramid decomposed image which is useful for describing problems in estimating image motion using standard optical flow and pyramid techniques.

FIG. 2 is a flowchart of the multiple hypothesis method of motion estimation.

FIG. 3 is an image diagram that demonstrates use of the multiple hypothesis method of motion estimation to overcome incompatible images and motion problems for horizontal only motion.

FIG. 4 is an image diagram that demonstrates use of the multiple hypothesis method of motion estimation to overcome incompatible images and motion problems for unknown motion.

FIG. 5 is an image diagram that demonstrates use of the multiple hypothesis method of motion estimation to overcome incompatible images and motion problems for motion which is predominately in a single known direction.

### DETAILED DESCRIPTION

A convenient method to produce correspondence matching is to use optical flow. The present invention overcomes many of the problems associated with previous optical flow methods allowing the use of optical flow in a wider range of applications, such as tele-presence and motion analysis.

Large displacements or in general large disparities between pairs of cameras can not be handled by the standard optical flow algorithms because such displacements may not be within the capture range of gradient or search based methods. Ideally, one would like to have the large capture range of search based algorithms and precision in the optical flow values generated by gradient based algorithms. To overcome the problems of large displacement and small object incompatibility found in traditional optical flow methods, and to increase their applicability, the inventors have designed a multi-hypothesis optical flow/parallax estimation algorithm that combines features of large range search and high precision of coarse-to-fine gradient methods.

The algorithm starts with a set of hypotheses of fixed disparity. Estimates of flow at each point are refined with respect to each of the hypotheses. Selecting the best flow at each point generates the final optical flow.

As set forth above, it has been found that in tele-presence systems using traditional optical flow tweening methods, suitable tweened images are obtained only when the maximum angular separation between cameras is less than 620 -8°. In the present invention angular separations between cameras as high as 30°-40° have been used to produce realistic and accurate tweened images.

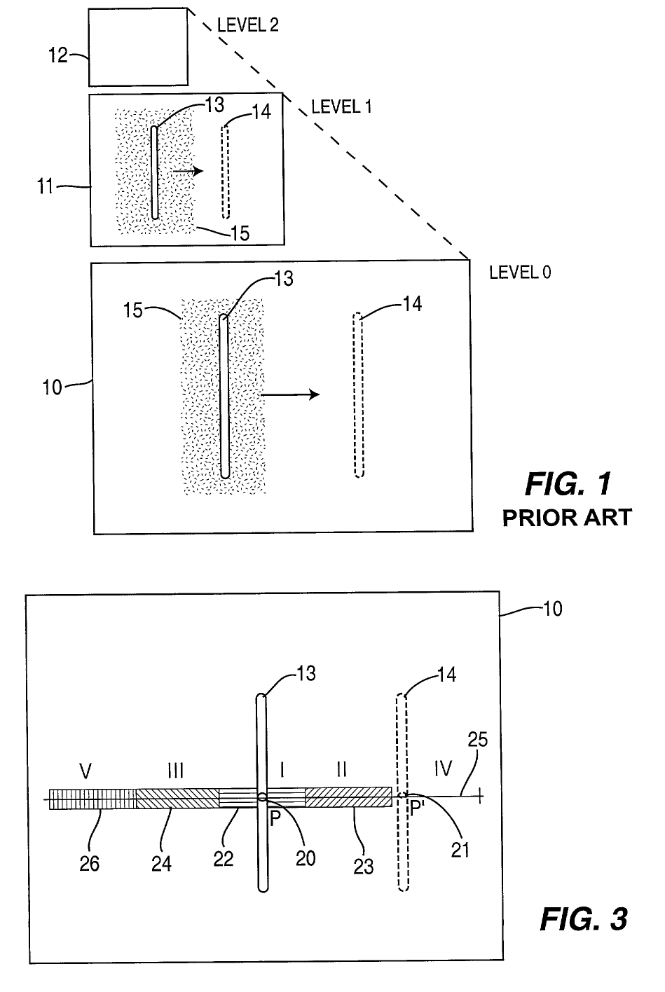

FIG. 1 is a diagram of a pyramid-decomposed image illustrating the problem of incompatible image and motion scales when optical flow is calculated using standard pyramid techniques. When working with objects of small image scale, displacement is ideally computed using high-resolution images, but at such resolutions traditional optical flow techniques cannot handle large displacements. Frame 10 in FIG. 1 represents two actual, pyramid level 0, images. A thin object 13 in the first image and the corresponding thin object 14 (shown in phantom) from a second image are superimposed. Region 15 shows the displacement of the thin object 13 that can be handled by traditional optical flow. As shown in FIG. 1, the displacement of the thin object is outside of the range that can be handled by the optical flow algorithms. Frame 11 shows the same image at the next lower resolution pyramid level. The displacement of the second image of the thin object 14′, with respect to the reference object 13′ is still outside of the region 15′ covered by traditional optical flow. At the next pyramid level 12 the thin object is no longer visible having been removed by the filtering process that reduces the resolution of the images. It should be noted that the displacement of the thin object might be due to motion of the object, parallax between the locations from which the images were taken, or a combination of both.

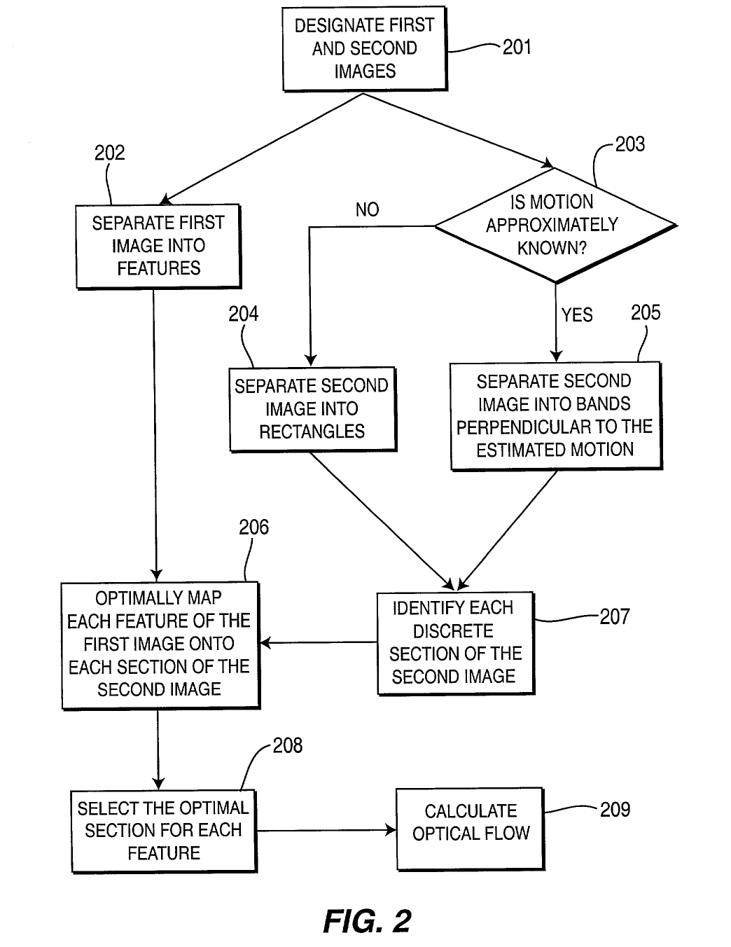

This problem of incompatible image and motion scales using standard optical flow and pyramid techniques led to the development of the multiple hypothesis optical flow method. FIG. 2 is a flowchart of the multiple hypothesis optical flow method of motion estimation.

In the multiple hypothesis optical flow method at step 201, first one image is designated as a first image and another as a second image. Next, at step 202, the first image is separated into a number of features. At step 207 the process makes multiple hypotheses about the displacement of an image feature from the first image to the second image by breaking the second image into bins. FIG. 3 is an image diagram that demonstrates use of the multiple hypothesis method of motion estimation to overcome incompatible images and motion problems for horizontal only motion. In the first image, feature 20 is in the bin marked 22. At step 204, the process separates the image into segments 23, 24, 25 and 26. Then, at step 206, for each segment (hypothesis), a traditional optical flow method is applied to find the best solution. In other words, the best position for the feature 20 in each bin is computed. In the final assembly process at step 208, the multiple solutions (hypotheses) are tested and the best one is chosen as the solution. Once of all the features have been optimally mapped the complete optical flow of the image is calculated at step 209. In FIG. 3 the correct hypothesis would be bin 25.

Numerous methods exist for separating the first image into features at step 202 are known to those skilled in the art. Among these methods are user designation of features offline, edge detection, filtering, and using an N×N block of pixels. An exemplary embodiment of the present invention uses N×N blocks of pixels where N is allowed to vary in inverse proportion to the amount of pixel to pixel variation in the region of the feature.

The choice of the best matching feature for a particular selected feature at step 208 can be based on a number of measures such as normalized correlation matching (or sum of absolute difference) score of a gray level or color window around the point, similarity in motion between neighboring pixels etc. Different approaches for checking alignment quality are described in a U.S. patent application Ser. No. 09/384,118, METHOD AND APPARATUS FOR PROCESSING IMAGES by K. Hanna, R. Kumar, J. Bergen, J. Lubin, H. Sawhney.

Alternatively, the choice of the best matching feature for a particular selected feature at step 208 can be based on a parallax rigidity constraint. The method of calculating a parallax rigidity constraint is described in a U.S. patent application Ser. No. 08/798,857, METHOD AND APPARATUS FOR THREE-DIMENSIONAL SCENE PROCESSING USING PARALLAX GEOMETRY OF PAIRS OF POINTS by P. Anandan and M. Irani. As with the prior example, the parallax rigidity constraint that provides the optimal fit for matches features in the various images is the globally optimal solution.

Many different methods may be used to generate the motion hypotheses at step 207. For instance when all the cameras are fixed on a particular object, features corresponding to the fixed background may have very large apparent motion among the various images. This motion may be outside the capture range of most motion estimation algorithms. The motion of the background features that is due to the positioning of the cameras can be pre-determined and stored in a database by a manual or semi-automatic calibration procedure, where known targets are placed in the scene.

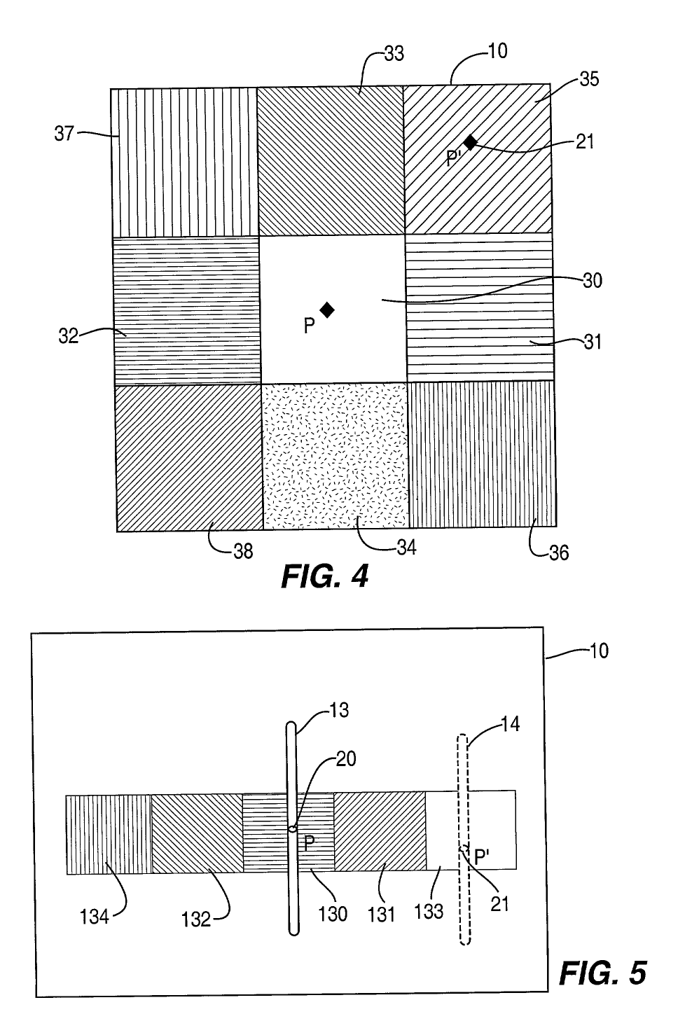

If the camera geometry is not known, the motion of each feature may be normalized to have two degrees of freedom, namely, horizontal motion and vertical motion 204. This may be done, for example, by adjusting the parameters of each image such that it appears to originate from a camera on the same surface as the other cameras. The coarse discretization of the motion space is shown in FIG. 4. The best solution in each cell is computed and the final result is chosen from them by an image error measurement such as normalized correlation. For an efficient implementation, the same hypothesis of all features is computed together, which is equivalent to shifting the whole image by certain amount first, then estimating the flow.

In many situations, the parameters of the imaging configuration are known at step 205. In this instance an epipolar constraint may be integrated into the computation. Basically, the epipolar constraint limits the motion space from 2D to 1D. For example, in a stereo setup, the apparent motion of stationary objects in the scene can only be along the line separating the cameras. The coarse discretization of the space creates a 1D strip of bins (see FIG. 3) instead of a 2D matrix of cells in the general motion case. As a result, fewer hypotheses are needed.

Sometimes, the camera parameters are only roughly known at step 205. For example, it may be known that two cameras are roughly on the same baseline and point to approximately the same direction. In this case, since it is known that the motion is roughly horizontal, the process at step 205 can use 1D horizontal hypotheses but allow 2D local computation of the flow as illustrated by FIG. 5.

It will be understood by those skilled in the art that many modifications and variations may be made to the foregoing preferred embodiment without substantially altering the invention.

What is claimed:

1. In a system used to analyze a plurality of digital images, a multiple hypothesis method to accomplish optical flow calculation, including recognition of large motions of thin objects, comprising;
a. selecting a first image and a second image from the plurality of digital images;
b. separating the second image into a plurality of discrete sections;
c. identifying a plurality of features in the first image;
d. using a direct optical flow method on one of the plurality of features of the first image to find a plurality of local optimal solutions corresponding to the plurality of discrete sections of the second image;
e. selecting a globally optimal solution from among the plurality of local optimal solutions; and
f. repeating steps d and e for each of the plurality of features of the first image.

2. The method of claim 1, wherein the step of separating the second image into the plurality of discrete sections comprises the step of dividing the second image into a plurality of rectangular blocks.

3. The method of claim 2, wherein the step of identifying the plurality of features in the first image includes the step of defining a plurality of N×N pixel blocks in the first image, each N×N block including a respective feature.

4. The method of claim 3, wherein N varies in inverse proportion to a pixel to pixel variation in a nearby region of the first image.

5. The method of claim 1, wherein the step of identifying the plurality of features in the first image includes receiving feature selections provided by an operator.

6. The method of claim 1, wherein the step of identifying the plurality of features in the first image includes selecting the features using an edge detection method.

7. The method of claim 1, wherein the step of selecting the globally optimal solution from among the plurality of local optimal solutions includes the step of optimizing a normalized correlation matching score of respective gray levels of a plurality of neighboring pixels in the second image relative to the first image.

8. The method of claim 1, wherein the step of selecting the globally optimal solution from among the plurality of local optimal solutions includes the step of optimizing a sum of a plurality of absolute difference scores of respective gray levels between a plurality of neighboring pixels in the first and second images.

9. The method of claim 1, wherein the step of selecting the globally optimal solution from among the plurality of local optimal solutions includes the steps of:
computing a parallax-related constraint for the plurality of features;
optimizing a parallax-related constraint to the plurality of local optimal solutions in order to select a globally optimal solution from among the plurality of local optimal solutions consistent with the parallax-related constraint.
